(19) United States
(12) Patent Application Publication
(10) Pub. No.: US 2012/0086238 A1
(43) Pub. Date: Apr. 12, 2012

(54) REINFORCED ROCKER PANEL STRUCTURE

(75) Inventor: Soo Aun Tan, Shelby Township, MI (US)

(73) Assignee: GM GLOBAL TECHNOLOGY OPERATIONS, INC., Detroit, MI (US)

(21) Appl. No.: 12/901,596

(22) Filed: Oct. 11, 2010

(51) Int. Cl. B62D 25/20

(52) U.S. Cl. 296/209

(57) ABSTRACT

A motor vehicle rocker panel is formed of a rocker inner panel and a rocker outer panel of generally C-shape that are spot welded together and cooperate to define an open space therebetween. An extruded aluminum reinforcement member is captured within an open space and includes a generally box-shaped structure having vertical sidewalls engaging respectively with the rocker inner panel and the rocker outer panel, and also integral flanges extending from the corners of the box-shape into engagement with the rocker inner panel and the rocker outer panel. Structural adhesive and screws act between the reinforcement member, the rocker inner panel, and the rocker outer panel, thereby providing a strong, lightweight, and economical reinforcement of the rocker panel. In addition, stiffening ribs are provided for strength and cavities are defined to receive the flow of any excess adhesive.

### FIELD OF THE INVENTION

The present invention relates to a motor vehicle body and more particularly provides a reinforced rocker panel structure.

### BACKGROUND OF THE INVENTION

Motor vehicle bodies conventionally have a rocker panel structure that extends lengthwise along the vehicle body to define the bottom of the front and rear door openings. Rocker panels typically include a rocker inner panel that is welded to the A-pillar, B-pillar and C-pillar. A rocker outer panel is welded to the rocker inner panel forming a box-shaped structure. The rocker structure must be strong and stiff to carry the necessary loads during use of the vehicle. It is known to improve the strength of the rocker structure by providing various stamped metal bulkheads, corner reinforcements, and brackets that are welded in place between the rocker inner panel and rocker outer panel. It is also known to increase the gauge of the metal used in the rocker outer panel and/or rocker inner panel.

It would be desirable to provide an improved rocker panel structure having greater strength, greater rigidity, lower mass, reduced assembly labor, lower cost, and greater design flexibility.

### SUMMARY OF THE INVENTION

A rocker inner panel extends longitudinally of the vehicle body and has a generally C-shaped channel opening outwardly. The C-shape of the rocker inner panel includes a vertical wall with an upper horizontal wall and a lower horizontal wall extending from the vertical wall, and also an upper weld flange extending upwardly from the upper horizontal wall and a lower weld flange extending downwardly from the lower horizontal extending wall. A rocker outer panel extends longitudinally of the vehicle body and has a generally C-shaped channel opening inwardly, the C-shaped channel including a vertical wall with an upper horizontal wall and a lower horizontal wall extending from the vertical wall. The rocker outer panel also includes an upper weld flange extending upwardly from the upper horizontal wall and a lower weld flange extending downwardly from the lower horizontal extending wall. A plurality of spot welds act between the upper and lower weld flanges of the rocker inner panel and the rocker outer panel so that the C-shaped channels of the rocker inner panel and the rocker outer panel cooperate to define an open space therebetween. An extruded aluminum reinforcement member of box-shaped cross-section is captured within the open space between the rocker inner panel and the rocker outer panel. The reinforcement member includes an inner vertical wall and an outer vertical wall that intersect with a top horizontal wall and a lower horizontal wall at corners of the reinforcement member. The reinforcement member has flange structures extending from each of the corners that extend into engagement with the adjacent one of the rocker inner panel and the rocker outer panel. A structural adhesive acts between the flange structures at the corners of the reinforcement member and the adjacent one of the rocker inner panel and the rocker outer panel. Fasteners also act between the flange structures at corners of the reinforcement member and the adjacent one of the rocker inner panel and rocker outer panel.

Further areas of applicability of the present invention will become apparent from the detailed description provided hereinafter. The detailed description and specific examples, while indicating exemplary embodiments of the invention, are for purposes of illustration only and not intended to limit the scope of the invention.

### BRIEF DESCRIPTION OF THE DRAWINGS

The present invention will become more fully understood from the detailed description and the accompanying drawings, wherein:

FIG. 1 is an exploded view of a vehicle body rocker structure and reinforcement therefore.

FIG. 2 is an exploded sectional view of a vehicle rocker panel structure and reinforcement therefore.

FIG. 3 is a view similar to FIG. 2 but showing the reinforcement member attached to the rocker outer panel.

FIG. 4 is a section view similar to FIGS. 2 and 3 but showing the rocker outer panel and the reinforcement member attached to the rocker inner panel.

### DETAILED DESCRIPTION OF THE EXEMPLARY EMBODIMENTS

The following description of certain exemplary embodiments is merely exemplary in nature and not intended to limit the invention, its application, or uses.

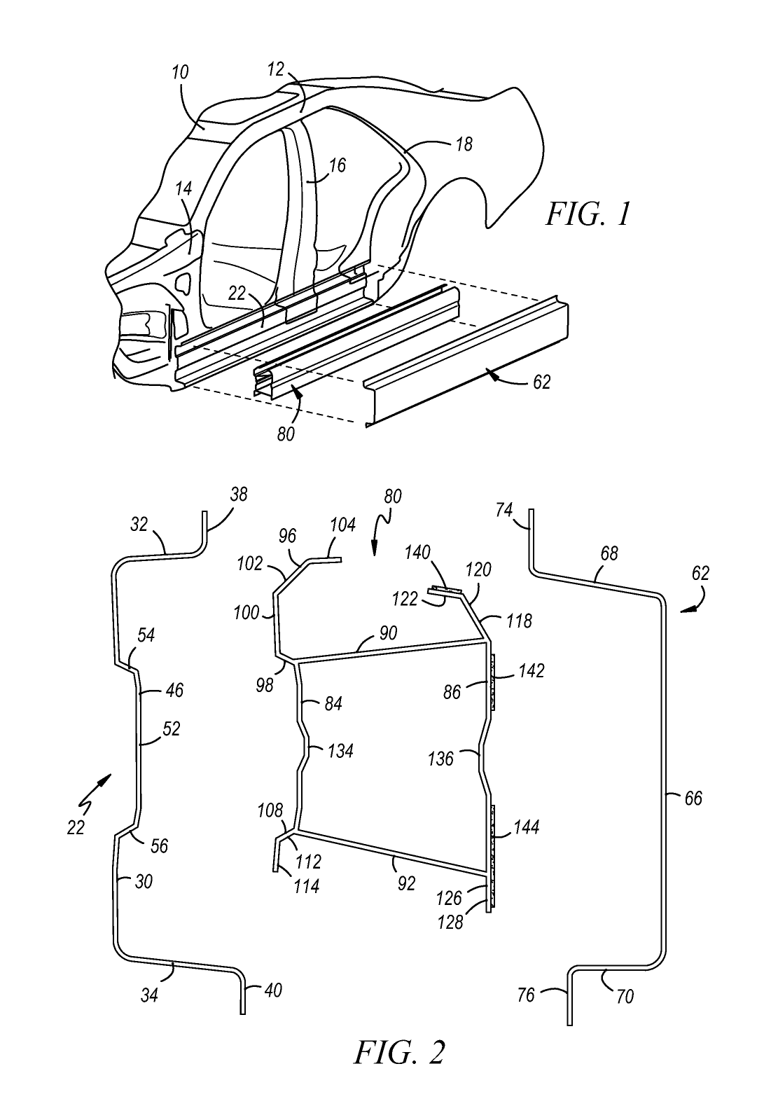

Referring to FIG. 1, a vehicle body, generally indicated at 10, is an assemblage of a number of stamped metal panels that are welded together. The vehicle body 10 includes a roof rail 12, an A-pillar structure 14, a B-pillar structure 16, a C-pillar structure 18, and a rocker inner panel 22 that extends generally horizontally over the length of the vehicle body between the A-pillar, B-pillar, and C-pillar.

As best seen in FIG. 2, the rocker inner panel 22 is a C-shaped channel that opens outwardly toward the exterior of the vehicle body. The rocker inner panel 22 is formed by stamping or roll-forming. The C-shaped channel includes a vertical wall 30, an upper horizontal wall 32, and a lower horizontal wall 34. An upper weld flange 38 extends upwardly from the upper horizontal wall 32, and a lower weld flange 40 extends downwardly from the lower horizontal wall 34. As best seen in FIG. 2, vertical wall 30 has a longitudinal extending rib structure 46. The rib structure 46 projects outwardly of the vehicle body 10, and includes a vertical rib wall 52, a top rib wall 54, and a lower rib wall 56. The rib structure 46 adds strength and rigidity to the rocker inner panel 22.

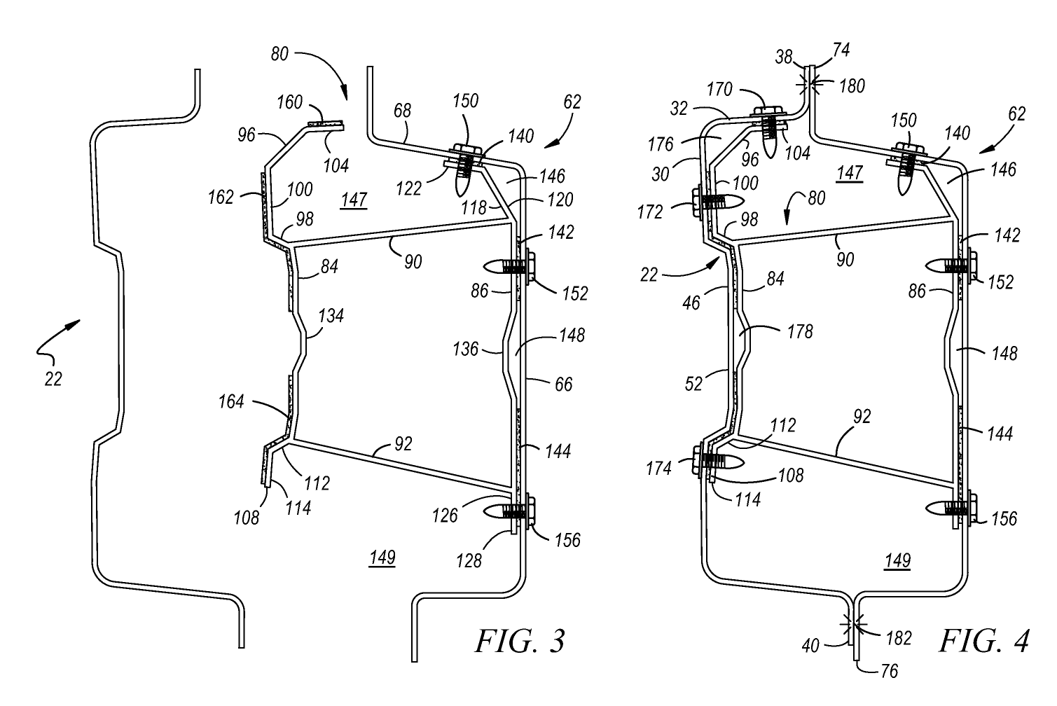

FIGS. 1 and 2 also show a rocker outer panel, generally indicated at 62. The rocker outer panel 62 is a stamping or roll-formed panel that extends longitudinally of the vehicle body 10 and is adapted to overlie and be attached to the rocker inner panel 22 of the vehicle body 10. As best seen in FIG. 2, the rocker outer panel 62 is a generally C-shaped channel that opens inwardly and includes a vertical wall 66, an upper horizontal wall 68, and a lower horizontal wall 70. An upper weld flange 74 extends upwardly from the upper horizontal wall 68, and a lower weld flange 76 extends downwardly from the lower horizontal wall 70. The rocker outer panel 62 will be attached to the rocker inner panel 22 by welding together the upper weld flanges 38 and 74, and also welding together the lower weld flanges 40 and 76, as shown in FIG. 4.

FIGS. 1 and 2 also show a reinforcement member, generally indicated at 80, for attachment within a hollow space between the rocker inner panel 22 and the rocker outer panel 62. As seen in FIGS. 1 and 2, the reinforcement member is an extruded aluminum member 80 having a longitudinal length that is coextensive with the length of the rocker inner panel 22 and the rocker outer panel 62. The extruded aluminum reinforcement member 80 is of a generally box-shaped construction including an inner vertical wall 84 and an outer vertical wall 86 that are connected together by a top horizontal wall 90 and a bottom horizontal wall 92.

A flange structure is provided at each corner of the generally box-shaped reinforcement member 80. As best seen in FIG. 2, the inner vertical wall 84 of the reinforcement member 80 has a flange structure 96 that is extruded integral with the reinforcement member 80 and includes an inwardly angled wall 98, a vertical leg 100, an outwardly angled leg 102, and a horizontal leg 104. The inner vertical wall 84 also includes a flange structure 108 at its lower end that includes an inwardly angled wall 112 and a vertical leg 114. The outer vertical wall 86 has an upper flange structure 118 including an inwardly angled wall 120 and a horizontal wall 122 that extends inwardly. The outer vertical wall 86 also has a flange structure 126 at the bottom thereof that includes a downward depending vertical leg 128. These flange structures 96, 108, 118, and 126, provided at the corners of the box-shaped reinforcement member 80 add strength and rigidity to the reinforcement member 80.

As seen in FIG. 2, the inner vertical wall 84 has an inwardly indented rib 134 that extends lengthwise along the inner vertical wall 84. The outer vertical wall 86 has a similar indented rib 136 that extends lengthwise along the outer vertical wall 86. These ribs 134 and 136 add strength and rigidity to the reinforcement member 80.

Referring to FIGS. 2 and 3, the reinforced rocker structure of this invention is assembled by first attaching the reinforcement member 80 onto the rocker outer panel 62. In FIG. 2, a bead of structural adhesive 140, is applied along horizontal wall 122 of upper flange structure 118. Another bead of adhesive 142, is applied to the outer vertical wall 86 just above the indented rib 136. Another bead of adhesive 144 is applied to the vertical wall 86 below the indented rib 136 and also extends onto the leg 128 of flange structure 126.

Thereafter, the reinforcement member 80 and the rocker outer panel 62 are pressed together to the position shown in FIG. 3. Then, a plurality of fasteners, preferably self tapping screws, are driven through the rocker outer panel 62 and into the reinforcement member 80 to hold the reinforcement member 80 and the rocker outer panel 62 closely and permanently together. In particular, screw 150 is installed between the upper horizontal wall 68 of the rocker outer panel 62 and the horizontal wall 122 of the upper flange structure 118. Screw 152 is installed between the vertical wall 66 of rocker outer panel 62 and the outer vertical wall 86 of the reinforcement member 80. Screw 156 is installed between the vertical wall 66 of the rocker outer panel 62 and the vertical leg 128 of the flange structure 126 of the outer vertical wall 86 of the reinforcement member 80.

The installation of the screws 150, 152, and 156 will squeeze the reinforcement member 80 and the rocker outer panel 62 together, and also squeeze the beads of adhesive 140, 142, 144. In the event that excessive adhesive was applied at bead of adhesive 140, the excess can flow into a cavity 146 defined between the angled wall 120 of flange structure 118 and the vertical wall 66 and upper horizontal wall 68 of the rocker outer panel 62, or into cavity 147. Likewise, if excessive adhesive is applied at the bead of adhesive 142, that excess can flow into either the cavity 146 or downwardly into a cavity 148 that is defined between the indented rib 136 of the reinforcement member 80 and the vertical wall 66 of the rocker outer panel 62. In addition, if an excess of adhesive is applied at the bead of adhesive 144, that excess can flow upwardly into the cavity 148 or can be extruded out beyond the bottom of the flange structure 126 into a cavity 149.

Next, as seen in FIG. 3, several beads of adhesive are applied to the reinforcement member 80. In particular, a bead of adhesive 160 is applied to the horizontal leg 104 of flange structure 96. A bead of adhesive 162 is applied along the vertical leg 100 of the flange 96 and also extends onto the angled wall 98 and part way onto the inner vertical wall 84. Another bead of adhesive 164 is applied to the inner vertical wall 84 just below the indented rib 134 and also extends along the angled wall 112 and vertical leg 114 of the flange structures 96 and 108.

After the application of these beads of adhesive 160, 162, and 164, the rocker reinforcement 80 and the rocker outer panel 62 of FIG. 3 are pressed into the rocker inner panel 22, as seen in FIG. 4. As seen in FIG. 4, the vertical rib wall 52 of the rib structure 46 of the rocker inner panel 22 will fit closely within and interlock with the corresponding indent in the reinforcement member 80 that is defined by the inner vertical wall 84 and the inwardly angled walls 98 and 112 of the flange structure 108.

Then, fasteners, preferably self-tapping screws, are installed between the rocker inner panel 22 and the reinforcement member 80. In particular, screw 170 is installed between the upper horizontal wall 32 of rocker inner panel 22 and the horizontal leg 104 of the flange structure 96 of the rocker reinforcement member 80. Another screw 172 is installed between the vertical wall 30 of the rocker inner panel 22 and the vertical leg 100 of the flange structure 96 of reinforcement member 80. In addition, screw 174 is installed between the vertical wall 30 of rocker inner panel 22 and the vertical leg 114 of flange structure 108.

Any excess adhesive applied at bead of adhesive 160, can flow into cavity 147 or a cavity 176 defined between the flange structure 96 and the rocker outer panel 62. Likewise, if excess adhesive is applied at the bead of adhesive 162, that excess can flow either upwardly into the cavity 176 or downwardly into a cavity 178 that is defined between the indented rib 134 of the reinforcement member 80 and the vertical rib wall 52 of the rocker inner panel 22. In addition, if an excess of adhesive is applied at the bead of adhesive 164, that excess can flow upwardly into the cavity 178 or can be extruded out beyond the bottom of the flange structure 108 into the cavity 149.

A series of spot welds 180 is made along the length of the structure between the upper weld flange 38 of rocker inner panel 22 and the upper weld flange 74 of the rocker outer panel 62. Likewise, a series of spot welds 182 is made between the lower weld flange 40 of the rocker inner panel 22 and the lower weld flange 76 of the rocker outer panel 62.

As seen in FIG. 4, the various screws 150, 152, 156, 170, 172, and 174 are preferably driven directly through the structural adhesive and will function to hold the parts tightly together and pressurize the structural adhesive. As the vehicle body is conveyed through the paint curing ovens, the beads of structural adhesive will be fully cured. Upon curing of the adhesive, the combination of the structural adhesive and the screws and the spot welds will permanently attach the reinforcement member 80 in its reinforcing location captured tightly within the confines of the rocker inner panel 22 and the rocker outer panel 62.

Although the drawings herein show the reinforcement member 80 first connected to the rocker outer panel 62, it will be understood that the order of assembly could be altered. If desired, the reinforcement member 80 would be installed onto the rocker inner panel 22, and then, later, the rocker outer panel 62 would then be applied onto the previously assembled together rocker inner panel 22 and reinforcement member 80. In addition it may be desirable that the length of the reinforcement member extend further beyond the A-pillar at the front and/or the C-pillar at the rear. Although the drawings show the reinforcement member as a simple box, the box-shape can have additional internal walls to add strength to the box.

Thus, it is seen that the invention has provided a new and improved rocker panel reinforcement for a motor vehicle.

What is claimed is:

1. A reinforced rocker structure for a vehicle body comprising:
a rocker inner panel extending longitudinally of the vehicle body and having a generally C-shaped channel opening outwardly, said channel including a vertical wall with an upper horizontal wall and a lower horizontal wall extending from the vertical wall; and, an upper weld flange extending upwardly from the upper horizontal wall and a lower weld flange extending downwardly from the lower horizontal wall;
a rocker outer panel extending longitudinally of the vehicle body and having a generally C-shaped channel opening inwardly, said channel including a vertical wall with an upper horizontal wall and a lower horizontal wall extending from the vertical wall; and, an upper weld flange extending upwardly from the upper horizontal wall and a lower weld flange extending downwardly from the lower horizontal wall;
a reinforcement member of box-shaped cross section including an inner vertical wall and an outer vertical wall that is spaced outwardly from the inner vertical wall by a top horizontal wall and a lower horizontal wall;
a structural adhesive acting between the rocker inner panel and the reinforcement member and also acting between the rocker outer panel and the reinforcement member;
and a plurality of spot welds acting between the upper and lower weld flanges of the rocker inner panel and the rocker outer panel.

2. The reinforced rocker structure of claim 1 further comprising a plurality of fasteners extending between the reinforcement member and the rocker inner panel to attach the reinforcement member to the rocker inner panel.

3. The reinforced rocker structure of claim 1 further comprising a plurality of fasteners extending between the reinforcement member and the rocker outer panel to attach the reinforcement member to the rocker outer panel.

4. The reinforced rocker structure of claim 1 further comprising a plurality of fasteners extending between the reinforcement member and the rocker inner panel to attach the reinforcement member to the rocker inner panel and a plurality of fasteners extending between the reinforcement member and the rocker outer panel to attach the reinforcement member to the rocker outer panel.

5. The reinforced rocker structure of claim 1 further comprising a plurality of flange structures provided on the reinforcement member, said flange structures being attached to the rocker inner panel and the rocker outer panel by the structural adhesive.

6. The reinforced rocker structure of claim 1 further comprising an indented rib provided on at least one of the vertical walls of the reinforcement member to strengthen the reinforcement member and provide a cavity for receiving the flow of any excess of the structural adhesive.

7. The reinforced rocker structure of claim 1 further comprising the rocker inner panel having a rib structure provided thereon and said rib structure fitting closely within corresponding structure on the reinforcement member to interlock the reinforcement member to the rocker inner panel.

8. The reinforced rocker structure of claim 7 further comprising the corresponding structure provided on the reinforcement member including the inner vertical wall of the reinforcement member and upper and lower flange structures provided on the reinforcement member.

9. The reinforced rocker structure of claim 1 further comprising the reinforcement member having corners where the vertical walls intersect with the horizontal walls, and a flange structure provided at each of the corners and extending therefrom into engagement with the adjacent one of the rocker inner panel and rocker outer panel, and the structural adhesive acting between each of the flange structures and the adjacent one of the rocker inner panel and rocker outer panel.

10. The reinforced rocker structure of claim 9 further comprising a screw installed between each of the flange structures of the reinforcement member and the adjacent one of the rocker inner panel or rocker outer panel.

11. The reinforced rocker structure of claim 1 further comprising the reinforcement member being of extruded aluminum manufacture.

12. The reinforced rocker structure of claim 1 further comprising the reinforcement member, the rocker inner panel, and the rocker outer panel being generally coextensive in length and extending between an A-pillar, B-pillar, and C-pillar of the vehicle body.

13. A reinforced rocker structure for a vehicle body comprising:
a rocker inner panel extending longitudinally of the vehicle body and having a generally C-shaped channel opening outwardly, said channel including a vertical wall with an upper horizontal wall and a lower horizontal wall extending from the vertical wall, and an upper weld flange extending upwardly from the upper horizontal wall and a lower weld flange extending downwardly from the lower horizontal extending wall;
a rocker outer panel extending longitudinally of the vehicle body and having a generally C-shaped channel opening inwardly, said channel including a vertical wall with an upper horizontal wall and a lower horizontal wall extending from the vertical wall, and an upper weld flange extending upwardly from the upper horizontal wall and a lower weld flange extending downwardly from the lower horizontal extending wall;
a plurality of spot welds acting between the upper and lower weld flanges of the rocker inner panel and the rocker outer panel so that the C-shaped channels of the rocker inner panel and the rocker outer panel cooperate to define a open space there between;
a reinforcement member of box-shaped cross section tightly captured within the open space between the rocker inner panel and rocker outer panel, the reinforcement member including an inner vertical wall and an outer vertical wall that intersect with a top horizontal wall and a lower horizontal wall at corners of the reinforcement, member, the reinforcement member also having a flange structure at each of the corners that extends into engagement with the adjacent one of the rocker inner panel and the rocker outer panel;
a structural adhesive acting between the flange structures at the corners of the reinforcement member and the adjacent one of the rocker inner panel and rocker outer panel;
and fasteners acting between the flange structures at corners of the reinforcement member and the adjacent one of the rocker inner panel and rocker outer panel.

14. The reinforced rocker structure of claim 13 further comprising the vertical walls of the reinforcement member engaging with the vertical walls of the inner rocker panel and outer rocker panel.

15. The reinforced rocker structure of claim 14 further comprising the structural adhesive and the fasteners acting between the vertical walls of the reinforcement member and the rocker inner panel and rocker outer panel.

16. The reinforced rocker structure of claim 13 further comprising an indented rib provided on at least one of the vertical walls of the reinforcement member to strengthen the reinforcement member and provide a cavity for receiving the flow of any excess of the structural adhesive.

17. The reinforced rocker structure of claim 13 further comprising an indented rib provided on each of the vertical walls of the reinforcement member to strengthen the reinforcement member and provide a cavity for receiving the flow of any excess structural adhesive.

18. A reinforced rocker structure for a vehicle body comprising:
a rocker inner panel extending longitudinally of the vehicle body and having a generally C-shaped channel opening outwardly, said channel including a vertical wall with an upper horizontal wall and a lower horizontal wall extending from the vertical wall, and an upper weld flange extending upwardly from the upper horizontal wall and a lower weld flange extending downwardly from the lower horizontal extending wall;
a rocker outer panel extending longitudinally of the vehicle body and having a generally C-shaped channel opening inwardly, said channel including a vertical wall with an upper horizontal wall and a lower horizontal wall extending from the vertical wall, and an upper weld flange extending upwardly from the upper horizontal wall and a lower weld flange extending downwardly from the lower horizontal extending wall;
a plurality of spot welds acting between the upper and lower weld flanges of the rocker inner panel and the rocker outer panel so that the C-shaped channels of the rocker inner panel and rocker outer panel cooperate to define a open space therebetween;
a reinforcement member of box-shaped cross section captured within the open space between the rocker inner panel and the rocker outer panel, the reinforcement member including an inner vertical wall and an outer vertical wall that intersect with a top horizontal wall and a lower horizontal wall at corners of the reinforcement member, said reinforcement member also having a flange structure extending from each of the corners and engaging with the adjacent one of the rocker inner panel and rocker outer panel;
a structural adhesive acting between the flange structures at the corners of the reinforcement member and the adjacent one of the rocker inner panel and rocker outer panel, the structural adhesive also acting between the vertical walls of the reinforcement member and the vertical walls of the adjacent one of the inner rocker panel and outer rocker panel;
and self tapping screws acting between the flange structures at corners of the reinforcement member and the adjacent one of the rocker inner panel and rocker outer panel.

19. The reinforced rocker structure of claim 18 further comprising the rocker inner panel having a rib structure provided thereon and said rib structure fitting closely within corresponding structure on the reinforcement member to interlock the reinforcement member to the rocker inner panel.

20. The reinforced rocker structure of claim 19 further comprising the corresponding structure provided on the reinforcement member including the inner vertical wall of the reinforcement member and upper and lower flange structures provided on the reinforcement member.
